(19) United States
(12) Patent Application Publication
(10) Pub. No.: US 2026/0254400 A1
(43) Pub. Date: Aug. 27, 2026

(54) SUPPORT STRUCTURES FOR SOLAR TRACKER SYSTEMS WITH INCREASED FLEXIBLITY

(71) Applicant: Nextpower LLC, Fremont, CA (US)

(72) Inventors: Alexander W. Au, Oakland, CA (US); Harry Van, Oakland, CA (US); Zachary Forrest Steele, Belmont, CA (US); Ryan Patel, Pleasanton, CA (US); Matheus Martins Lopes Machado, Sorocaba - SP (BR)

(21) Appl. No.: 19/539,435

(22) Filed: Feb. 13, 2026

Related U.S. Application Data
(60) Provisional application No. 63/762,340, filed on Feb. 24, 2025.

(51) Int. Cl. H02S 20/23; F24S 25/12; F24S 25/13; F24S 25/617; F24S 25/70; F24S 30/425

(52) U.S. Cl. CPC H02S 20/23; F24S 25/12; F24S 25/13; F24S 25/617; F24S 25/70; F24S 30/425

(57) ABSTRACT

A solar tracker system having support piers including a first support pier and a second support pier. Each of the first and second support piers include a lower portion having a first ground pile and a second ground pile, respectively, and an upper portion having a first angled leg and a second angled leg coupled to each other proximate a top of the upper portion. The upper portion coupled to the lower portion via a first attachment joint and a second attachment joint, and the upper portion configured to rotate relative to the lower portion via the first attachment joint and the second attachment joint. The solar tracker system further including a torque tube rotatably supported by the support piers, a plurality of solar modules coupled to the torque tube, and a drive motor configured to cause the torque tube to rotate.

### RELATED APPLICATIONS

This application claims the benefit of U.S. Provisional Patent Application No. 63/762,340, filed Feb. 24, 2025, the entire contents of which are incorporated herein by reference.

### TECHNICAL FIELD

This disclosure relates generally to solar power generation systems, and more particularly, to support structures for solar arrays within a solar tracking system.

### BACKGROUND

Solar panels can convert sunlight into energy. As an example, solar thermal panels often convert electromagnetic radiation from the sun into thermal energy for heating homes, running certain industrial processes, or driving high grade turbines to generate electricity. As another example, solar photovoltaic panels convert sunlight directly into electricity for a variety of applications. Solar panels are generally composed of an array of solar cells, which are interconnected to each other. The cells are often arranged in series and/or parallel groups of cells in series. Accordingly, solar panels have great potential to benefit our nation, security, and human users. They can even diversify our energy requirements and reduce the world's dependence on oil and other potentially detrimental sources of energy.

Solar tracking systems can be used to dynamically orient a plurality of solar modules, for instance, by moving the solar modules throughout the course of a given day to track the movement of the sun and thereby increase the efficiency and productivity of the solar modules. However, because solar tracking systems apply motive force to move the solar modules, resulting forces can be imparted on the piles that support the movable solar modules. In addition, the solar modules can experience natural forces in the field, such as wind loads, which can create additional acting forces on the piles that support the movable solar modules.

Further, during operation of the solar tracker, thermal fluctuations occur daily and seasonably resulting in thermal expansion and contraction of the solar tracker components. In many instances, thermal expansion is not significant enough to impart noticeable forces on the components. However, the torque tubes of the solar trackers can span significant lengths, which results in noticeable expansion and contraction during daily and seasonal temperature fluctuations.

The thermal expansion and contraction of torque tubes can impart significant loads on the couplings and the piers supporting them. Axial forces due to expansion and contraction of the torque tube can cause the piers to deflect or otherwise deform to accommodate this axial movement by the torque tube. This deflection by the piers can cause misalignment of the couplings with respect to the torque tubes, which can cause increased friction or binding of the torque tube as the torque tube is rotated within the couplings. This binding or increased friction increases the amount of force required to rotate the torque tube, which in turn, imparts increased load on the actuators or motors effectuating the rotation, and in some instances can cause the torque tube to twist along its length, causing some solar panels to rotate more or less than other solar panels along the length of the torque tube. The present disclosure seeks to address the shortcomings of prior tracker systems.

### SUMMARY

In general, the present disclosure relates to support structures for solar arrays within a solar tracking system. In one example, a support structure may include an upper portion that may include a first angled leg and a second angled leg, the first angled leg and the second angled leg coupled to each other proximate a top of the upper portion, the first angled leg and the second angled leg crossing over each other at an intersection, and a lower portion that may include a first ground pile and a second ground pile, the first angled leg configured to couple to the second ground pile via a second joint and the second angled leg configured to couple to the first ground pile via a first joint.

Additionally or alternatively, the first angled leg and the second angled leg may be coupled at the top of the upper portion via a connector portion, the first angled leg coupled to a first end of the connector portion and the second angled leg coupled to a second end of the connector portion.

Additionally or alternatively, the first angled leg may be coupled to an exterior surface of the second ground pile, and the second angled leg is coupled to an exterior surface of the first ground pile.

Additionally or alternatively, the first angled leg may comprise a first top portion and a first end portion, and the second angled leg comprises a second top portion and a second end portion.

Additionally or alternatively, the first ground pile may include a first top portion, the first top portion of the first ground pile defining a first hole for the first joint, the second end portion of the second angled leg defining a second hole for the first joint, the first hole and the second hole of the first joint being aligned when the second angled leg is coupled to the first ground pile via a fastener passing through the first hole and the second hole, the first joint enabling relative movement between the second angled leg and the first ground pile.

Additionally or alternatively, the second ground pile may include a second top portion, the second top portion of the second ground pile defining a first hole for the second joint, the first end portion of the first angled leg defining a second hole for the second joint, the first hole and the second hole of the second joint being aligned when the first angled leg is coupled to the second ground pile via fastener passing through the first hole and the second hole, the second joint enabling relative movement between the first angled leg and the second ground pile.

Additionally or alternatively, the first top portion and the second end portion may be located on a first side of the intersection, and the second top portion and the first end portion are located on a second side of the intersection, the second side being opposite the first.

Additionally or alternatively, the first angled leg and the second angled leg may be further coupled to each other at the intersection.

Additionally or alternatively, the first angled leg and the second angled leg may couple to each other at the intersection via a fastener, the fastener enabling relative rotation between the first angled leg and the second angled leg about the fastener.

Additionally or alternatively, proximate the intersection, each of the first angled leg and the second angled leg may include a swaged portion, each of the swaged portions having an outer diameter that is less than an outer diameter of the respective first angled leg or the second angled leg.

Additionally or alternatively, the upper portion may be configured to rotate relative to the lower portion.

In another example, a solar tracker system may include a plurality of support piers including a first support pier and a second support pier. Each of the first and second support piers may include a lower portion having a first ground pile and a second ground pile configured to be at least partially embedded within the ground, and an upper portion having a first angled leg and a second angled leg coupled to each other proximate a top of the upper portion, the upper portion may be configured to be coupled to the lower portion via a first attachment joint and a second attachment joint, the upper portion configured to rotate relative to the lower portion via the first attachment joint and the second attachment joint. The solar tracker system may further include a torque tube rotatably supported by the plurality of support piers, a plurality of solar modules coupled to the torque tube, and a drive motor configured to cause the torque tube to rotate.

Additionally or alternatively, the first angled leg and the second angled leg may cross over each other at an intersection.

Additionally or alternatively, the first angled leg and the second angled leg may be coupled to each other at the intersection.

Additionally or alternatively, the first angled leg and the second angled leg may couple to each other at the intersection via a fastener, the fastener enabling relative rotation between the first angled leg and the second angled leg about the fastener.

Additionally or alternatively, each of the first and second support piers may further include a connector portion coupling the first angled leg and the second angled leg together, the connector portion coupled at a first connector end to the first angled leg and at a second connector end to the second angled leg.

Additionally or alternatively, the first angled leg may comprise a first top portion and a first end portion, and the second angled leg may comprise a second top portion and a second end portion, the first end portion and the second end portion being swaged.

Additionally or alternatively, the first angled leg may comprise a first top portion and a first end portion, and the second angled leg may comprise a second top portion and a second end portion, the first end portion and the second end portion being at least partially flattened.

Additionally or alternatively, the first angled leg may be coupled to the second ground pile via the second attachment joint via a fastener, about which the first angled leg rotates relative to the second ground pile.

Additionally or alternatively, the second angled leg may be coupled to the first ground pile via the first attachment joint via a fastener, about which the second angled leg rotates relative to the first ground pile.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings, wherein:

FIG. 1 is an elevation view of a solar tracker provided in accordance with the present disclosure;

FIG. 2 is a schematic, top view of a solar tracking system;

FIG. 3 is a front, perspective view of an example solar tracker in accordance with the present disclosure;

FIG. 4 is a back-side view of the example solar tracker, as in FIG. 3;

FIG. 5A is a back-side view the example solar tracker in a first rotated position;

FIG. 5B is a back-side view the example solar tracker in a second rotated position;

FIG. 6 is a perspective view of an example support structure, in accordance with the disclosure, in an exploded configuration;

FIG. 7 is a perspective view of the example support structure, as in FIG. 6;

FIG. 8A is a front view of an upper portion of the example support structure, as in FIG. 6;

FIG. 8B is a side view of the upper portion of the example support structure, as in FIG. 8A;

FIG. 9A is a front view of an upper portion of an example support structure in accordance with the present disclosure;

FIG. 9B is a side-perspective view of the upper portion of the example support structure, as in FIG. 9A; and

FIG. 9C is a bottom-perspective view of the upper portion of the example support structure, as in FIG. 9A.

### DETAILED DESCRIPTION

The following detailed description is exemplary in nature and is not intended to limit the scope, applicability, or configuration of the disclosure in any way. Rather, the following description provides some practical illustrations for implementing examples of the present disclosure. Those skilled in the art will recognize that many of the noted examples have a variety of suitable alternatives.

Embodiments disclosed herein include various devices, systems, and methods relating to solar tracker foundations. Certain embodiments disclosed herein relate to solar tracker supports configured to facilitate improved structural stability for solar tracking systems. Certain embodiments disclosed herein can improve solar tracking system structural stability while increasing the efficiency of solar tracking foundation installation and reducing costs (e.g., foundation and/or support material costs) associated with solar tracker foundations and supports.

During operation of solar trackers, thermal fluctuations occur daily and seasonably resulting in thermal expansion and contraction of the solar tracker components. In many instances, thermal expansion is not significant enough to impart noticeable forces on the components. However, the torque tubes of the solar trackers can span significant lengths, which results in noticeable expansion and contraction during daily and seasonal temperature fluctuations.

The thermal expansion and contraction of torque tubes can impart substantial axial loads on the support structures. The torque tubes of the solar tracker are rotatably supported on the piers by a coupling. These couplings enable the torque tube to rotate about its longitudinal axis and in many embodiments, enable the torque tube to axially slide within the coupling to accommodate thermal expansion and contraction of the torque tube. Axial movement of the torque tube can impart significant loads on the couplings and the piers supporting them. Axial forces due to expansion and contraction of the torque tube can cause the piers to deflect or otherwise deform to accommodate this axial movement by the torque tube. This deflection by the piers can cause misalignment of the couplings with respect to the torque tubes, which can cause increased friction or binding of the torque tube as the torque tube is rotated within the couplings. This binding or increased friction increases the amount of force required to rotate the torque tube, which in turn, imparts increased load on the actuators or motors effectuating the rotation, and in some instances can cause the torque tube to twist along its length, causing some solar panels to rotate more or less than other solar panels along the length of the torque tube. Embodiments herein may include piers and/or truss supports designed to increase flexibility in a north-south direction, aligning with the length of the torque tube, to accommodate deflection caused by thermal expansion. In such cases, the piers and/or truss supports may flex with the torque tube thereby preventing deformation due to axial forces via thermal expansion placed upon the torque tube.

Solar tracking systems may be used to dynamically orient a plurality of solar modules, for instance, by moving the solar modules throughout the course of a given day to track the movement of the sun (e.g., an east-west direction) and thereby increase the efficiency and productivity of the solar modules. However, because solar tracking systems apply motive force to move the solar modules, resulting forces can be imparted on the piles that support the movable solar modules. In addition, the solar modules can experience natural forces in the field, such as wind loads, which can create additional acting forces on the piles that support the movable solar modules. Embodiments disclosed herein may include piers and/or truss supports designed to increase the strength of the piers and/or truss supports in an east-west direction, as the solar modules track the movement of the sun. Further, the piers and/or truss supports disclosed herein may be designed to increase flexibility in a north-south direction, aligning with the length of the torque tube, to accommodate natural forces in the field, such as wind loads. In such cases, the piers and/or truss supports may flex with the wind thereby preventing deformation and/or damage due to forces placed upon the piers and/or truss supports.

Embodiments disclosed herein may be formed via a hydroforming process. Hydroforming may be a material-efficient process as it deforms the material rather than cutting it, minimizing waste and ultimately reducing costs. Hydroforming solar tracker components, such as those described herein, may offer superior design flexibility, such as, allowing for intricate shapes that create more streamlined and integrated solutions. Additionally, the resulting structures tend to be lighter, improving overall tracker efficiency and reducing foundation requirements. The stress distribution in hydroformed parts typically leads to better structural performance compared to welded joints, which can be weaker due to heat-affected zones. While hydroforming may entail higher initial setup costs, the reduction in material waste and labor can result in lower overall production costs, especially in high-volume applications.

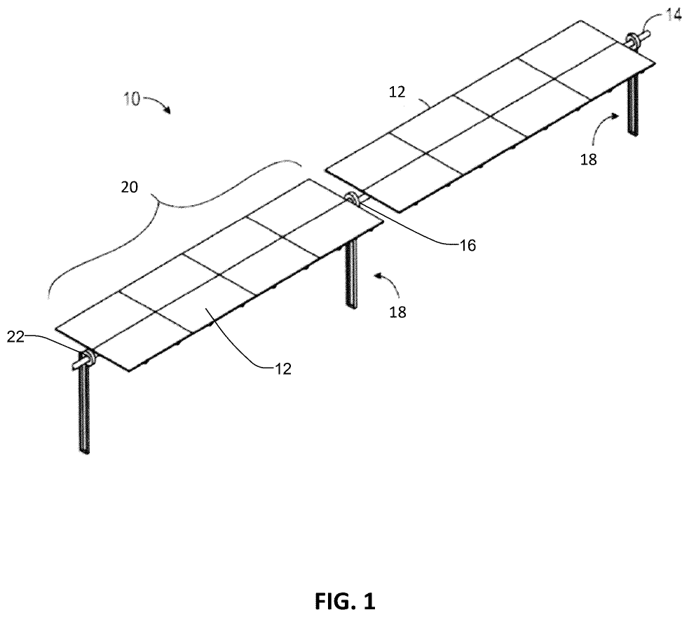

FIG. 1 is an elevation view of a common arrangement of a solar tracker 10 provided in accordance with the present disclosure. In some applications, a plurality of solar trackers 10 may be arranged in a north-south longitudinal orientation to form rows of a solar array. The solar tracker 10 may be formed of a plurality of bays 20 defined by the distance between ground pile support structures 18 (generally referenced herein as piles 18). The ground piles 18 may be disposed in spaced relation to one another and partially embedded in the earth. In some examples, the ground piles 18 may be multi-component tubular support members, or A-frame supports, and/or may be configured to couple to A-frame supports. The piles 18 may have one or more embedment in the ground, such as one for each leg of an A-frame support where the embedments are spaced apart in the east-west direction. FIG. 1 illustrates two bays 20 of the solar tracker 10. However, it will be appreciated that the solar tracker 10 may include four bays, six bays, ten bays, twenty bays, or any other suitable number of bays as desired. At each pile 18 is either a bearing 22 or generally near the center of the solar tracker 10 a drive mechanism 16. Each of the bearings 22 and the drive mechanism 16 are supported by one of the piles 18. Activation of the drive mechanism rotates a torque tube 14 about an axis of rotation and thus rotates one or more solar modules 12 mounted to the torque tube 14 such that the solar modules 12 can be oriented to a desired position. That desired position may be to a position to capture maximum sunlight based on the location of the sun in the sky, that position may be to a 0-angle position during times of diffuse light, the desired position may be a safety position based on weather conditions such as high winds or a snow storm, or any position in between as desired by the operators of the solar power plant in which the solar tracker 10 is located given the current weather and atmospheric conditions, the current demands of the grid, and other factors. The bearings 22 reduce to the extent possible the resistance to movement of the torque tube 14 and the solar modules 12.

The torque tube 14 is sized (e.g., diameter, wall thickness, material) such that sag between the piles 18 is reduced or substantially eliminated and to absorb torsional loads applied to the torque tube 14 by wind loading. In addition, since there is often just a single drive mechanism 16, the specifications for the torque tube 14 may desire to eliminate twist of the torque tube 14 along its length. Any twist would result in the solar modules 12 being oriented differently from what is desired, and thus again reduce the output and efficiency of the solar tracker 10, particularly, as the solar tracker 10 is rotated to the extreme angles of permitted range (e.g., +/−75 degrees or more), for example, during stowing.

As will be appreciated, the solar modules 12 must be supported on the torque tube 14. This is typically achieved by a bracket system (not shown in FIG. 1) that is attached to the torque tube 14 substantially perpendicular to the longitudinal axis of the torque tube 14. The torque tube 14 may be rotatable about its longitudinal axis to adjust an angular orientation of the solar modules 12 relative to the sun, while supporting the solar modules 12 on the bracket system. The bracket system may take many forms including two pieces of shaped steel, which may be arranged to sandwich the solar modules 12, and may be configured to connect to a rail, which is then coupled to the torque tube 14.

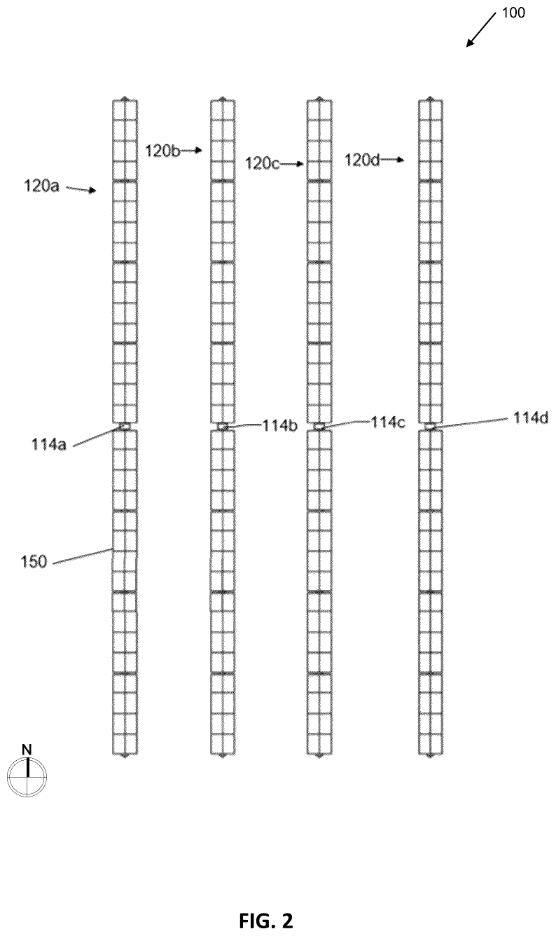

FIG. 2 is a top view of a solar tracker system 100 composed of a plurality of solar tracker rows, such as for example, a first solar tracker row 120a, a second solar tracker row 120b, a third solar tracker row 120c, and a fourth solar tracker row 120d (generally referred to herein as solar tracker rows 120). The solar tracker rows 120 may be arranged in parallel in a north-south direction, as shown in FIG. 2. It will be appreciated that directional language, e.g., north, south, east, west, referenced herein, is referring generally to such directions and not necessarily to the precise direction. For example, north-south, east-west directions may mean true north-south, true east-west, or approximately north, approximately south, approximately east, or approximately west, for example, within a ±44° range of true north-south, east-west. In some cases, the solar tracker rows 120 may include interior solar tracker rows, such as for example, solar tracker rows 120b, 120c, and exterior solar tracker rows, such as for example, solar tracker rows 120a, 120d. It will be appreciated that interior solar tracker rows are solar tracker rows 120 positioned between two other solar tracker rows 120, and exterior solar tracker rows are solar tracker rows 120 with one other solar tracker row 120 on one side of the exterior solar tracker row and no solar tracker row 120 positioned on the other side, opposite the one side of the exterior solar tracker row. The solar tracker rows 120 may be composed of a plurality of solar module assemblies 150 arranged in a north-south longitudinal orientation to form the solar tracker rows 120. The solar module assemblies 150 may include a plurality of solar modules, such as the solar modules 12, as in FIG. 1. Each one of the plurality of solar module assemblies 150 may be supported on a torque tube 114a, 114b, 114c, 114d (generally referred to herein as torque tube 114), which in turn is supported by a plurality of support piers (not explicitly shown in FIG. 2). The torque tube 114 may be an example of the torque tube 14, as in FIG. 1. As shown, the solar tracker rows 120 may be separated by a space sufficient to allow machinery to travel therethrough to allow for cleaning and maintenance.

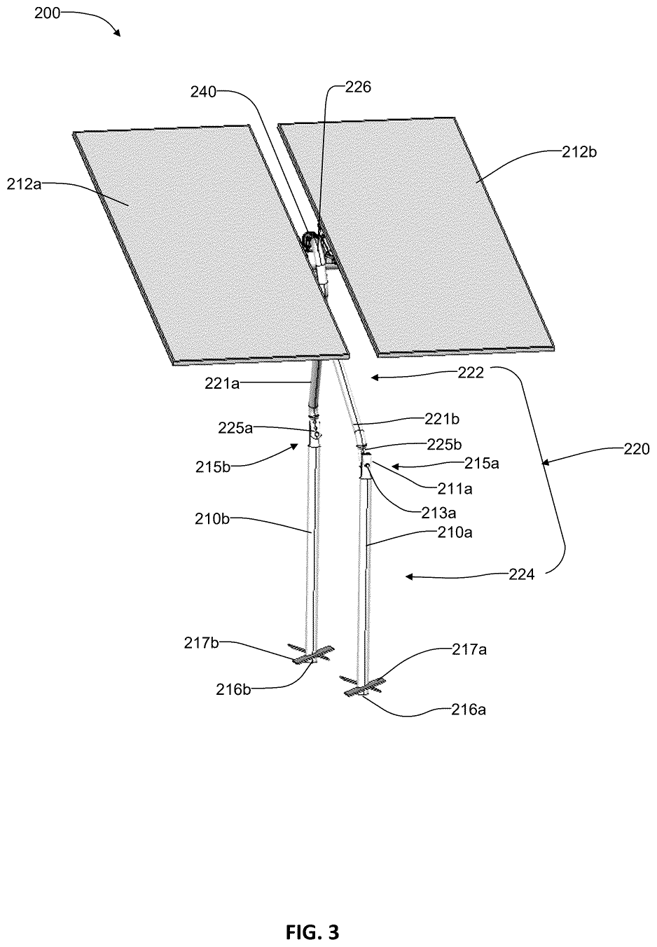

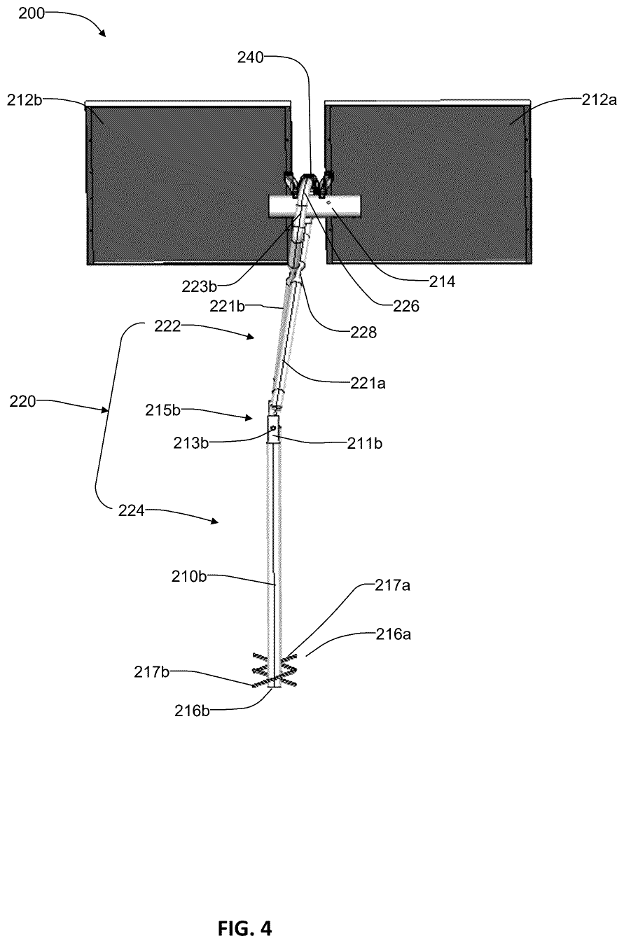

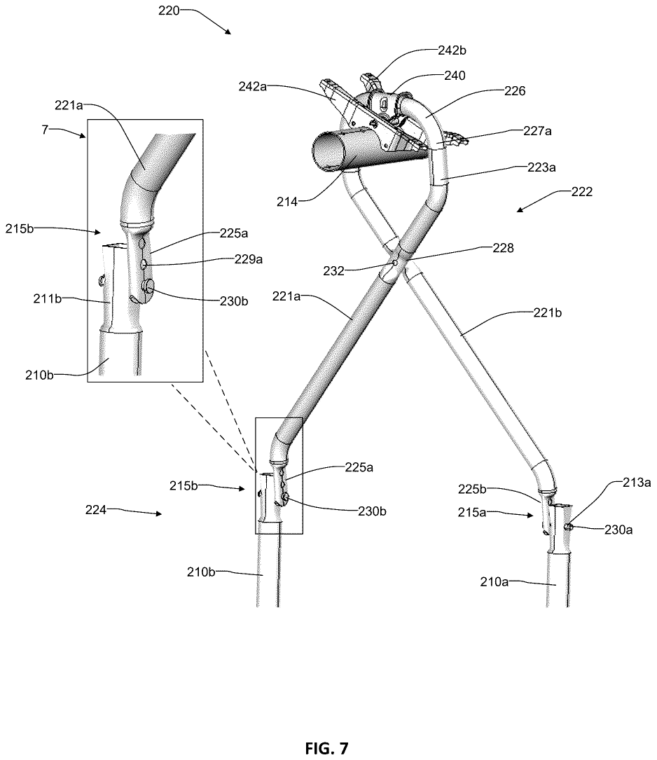

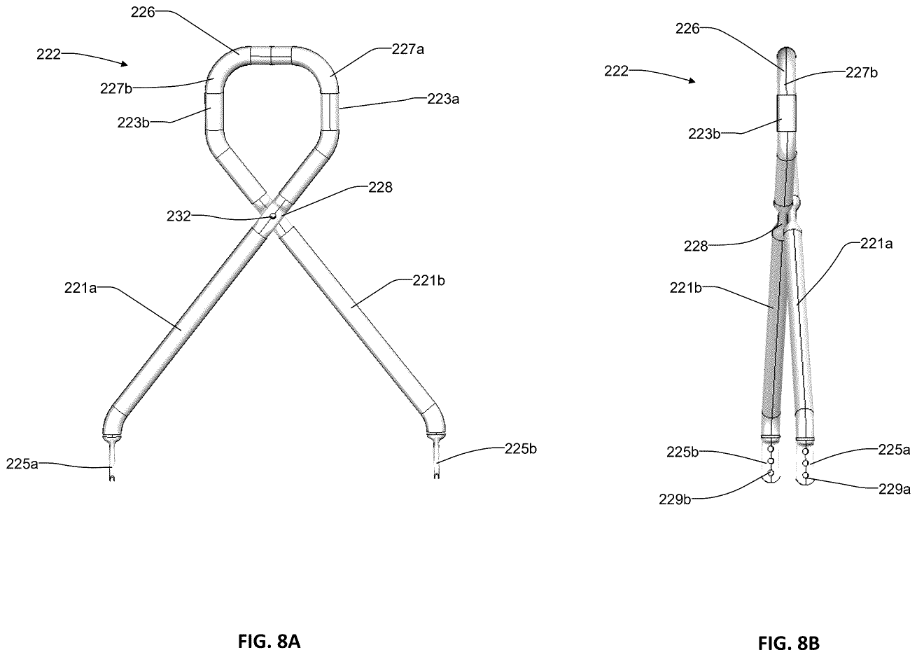

FIG. 3 is a front, perspective view of a solar tracker 200 in accordance with the present disclosure, and FIG. 4 is a back-side view of the solar tracker 200. The solar tracker 200 may include a support structure 220 having an upper portion 222 and a lower portion 224. The upper portion 222 may include a first angled leg 221a and a second angled leg 221b each attached to a connector portion 226. The first angled leg 221a and the second angled leg 221b may each comprise a hollow metal tube, though other shapes, materials, and cross-sections can be used. The first angled leg 221a and the second angled leg 221b may each terminate in a first end portion 225a and a second end portion 225b, respectively. The first end portion 225a and the second end portion 225b may each have a smaller diameter than the first angled leg 221a and the second angled leg 221b, respectively. For example, in some examples the first end portion 225a and the second end portion 225b may each be swaged such that each end portion 225a, 225b may be inserted into a corresponding opening defined by the lower portion 224 of the support structure 220. In some examples, as described herein, the first end portion 225a and the second end portion 225b may comprise a flattened portion including a plurality of holes (plurality of holes 229a, 229b shown in FIGS. 7 and 8B).

The first end portion 225a and the second end portion 225b of the upper portion 222 may each be coupled to a second top portion 211b of a second ground pile 210b and a first top portion 211a of a first ground pile 210a, respectively. The plurality of holes of the first end portion 225a and the second end portion 225b may align with one or more holes positioned within the second top portion 211b and the first top portion 211a, respectively, and may be coupled together via a fastener (e.g., bolt, screw, rod), as will be shown in further detail with reference to FIG. 7, thereby forming a second attachment joint 215b and a first attachment joint 215a, respectively. Each fastener may pass through the plurality of holes in each end portion 225a, 225b and the one or more holes in each top portion 211b, 211a which are aligned with one another when each of the first end portion 225a and the second end portion 225b of the upper portion 222 are positioned adjacent the second top portion 211b and the first top portion 211a, respectively. In some examples, a nut, clip, or the like can be used with the fastener to secure the fastener through the plurality of holes in the upper portion 222 and the one or more holes in the lower portion 224.

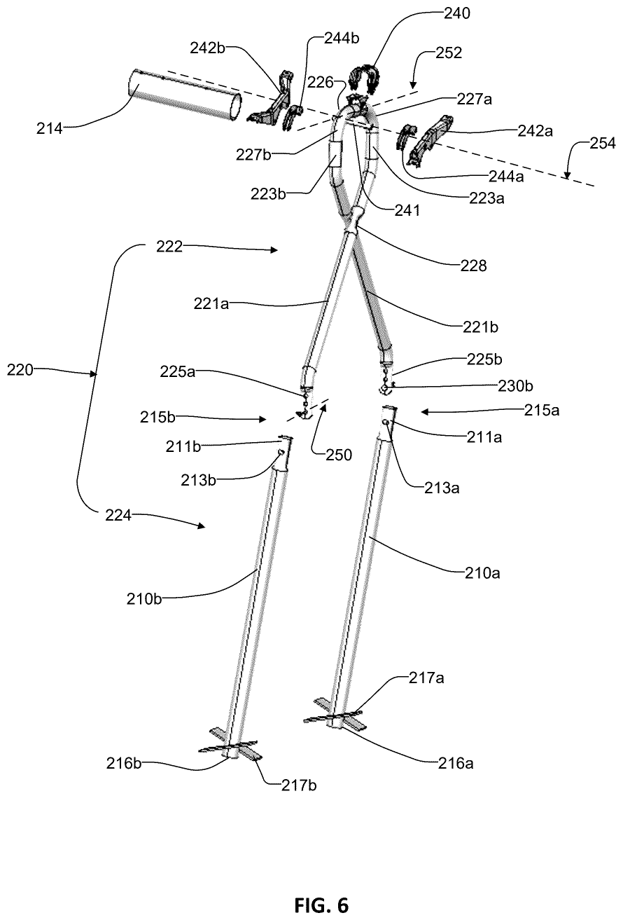

Because the first angled leg 221a and the second angled leg 221b are each coupled to a respective ground pile 210b, 210a by a single fastener, and because the first end portion 225a and the second end portion 225b of the upper portion 222 are positioned adjacent the second top portion 211b and the first top portion 211a, respectively, the upper portion 222 can rotate relative to the lower portion 224. In the illustrated example of FIG. 2, the frame 212 can rotate about a horizontal axis 250 (shown in FIG. 6) defined by the fasteners 230a, 230b. Accordingly, the upper portion 222 can move laterally relative to the underlying ground.

The upper portion 222 may be formed as a looped A-frame in which a first top portion 223a of the first angled leg 221a may be coupled to a first end 227a of the connector portion 226 and a second top portion 223b of the second angled leg 221b may be coupled to a second end 227b of the connector portion 226. In some examples, the first top portion 223a and the second top portion 223b may each be swaged such that each top portion 223a, 223b may be inserted into a corresponding opening defined by the first end 227a of the connector portion 226 and the second end 227b of the connector portion 226, respectively. The first angled leg 221a and the second angled leg 221b may cross over one another at an intersection 228. In such an example, the first top portion 223a may be coupled to the first end 227a of the connector portion 226 and the first end portion 225a may be coupled to the second top portion 211b of the second ground pile 210b. Similarly, the second top portion 223b may be coupled to the second end 227b of the connector portion 226 and the second end portion 225b may be coupled to the first top portion 211a of the first ground pile 210a. The portions of the first angled leg 221a and the second angled leg 221b that form the intersection 228 may each be swaged such that the portions that form the intersection 228 each include an outer diameter that is less than an outer diameter of each angled leg 221a, 221b of the upper portion 222. The first angled leg 221a and the second angled leg 221b may be coupled to one another at the intersection 228 via a fastener (fastener 232 shown in FIGS. 7 and 8A), e.g., a bolt, a screw, a rod, or the like.

The lower portion 224 may include the first ground pile 210a and the second ground pile 210b. The first ground pile 210a may be formed from an elongate tube extending from the first top portion 211a to a first end portion 216a, and the second ground pile 210b may be formed from an elongate tube extending from the second top portion 211b to a second end portion 216b. As previously discussed, the first top portion 211a and the second top portion 211b may each include one or more holes 213a, 213b, respectively. In some examples, the first top portion 211a and the second top portion 211b may each be swaged. In other examples, the first ground pile 210a and the second ground pile 210b may each include an outer diameter that is consistent along the length of the elongate tube. The first end portion 216a and the second end portion 216b may each include one or more retention features 217a, 217b configured to engage with an underlying ground in which the support structure 220 is implanted by being screwed or threaded into the ground to anchor the solar tracker 200. While it is shown that the one or more retention features 217a, 217b may include blades, it may be contemplated that other types of retention features may be used. Such as for example, angled blades, helical ridges, vertical ridges, spade blades, paddle blades, screw threads, or the like. These are just examples.

The support structure 220 may be formed from aluminum, brass, carbon, stainless steel, copper, or other metal alloys. In some cases, the support structure 220 may be formed via a hydroforming process. In such cases, the support structure may be formed of a material and a thickness appropriate for forming the particular components, such as, for example, retention features 217a, 217b, attachments joints 215a, 215b, etc. described herein. In some cases, the support structure 220 may be formed via extrusion, welding, molding, and or any other suitable process. The addition of retention features 217a, 217b to the support structure 220 during the manufacturing process may be advantageous in diverse soil conditions soil conditions (e.g., sandy soil, clay soil, silt soil, peat soil, loam soil, among others) by providing reliable support for solar trackers in rural and/or urban environments.

Continuing with the embodiment of FIGS. 3 and 4, the support structure 220 may further include a pivot bracket 240. The pivot bracket 240 may be configured to be rotatably coupled to the connector portion 226 of the support structure 220 and may be configured to support/effectively couple the torque tube 214 to the support structure 220. In some examples, the connector portion 226 of the support structure 220 may be inserted into the pivot bracket 240, however, in some examples, the pivot bracket 240 may be configured to fit around the connector portion 226 of the support structure 220. For instance, the pivot bracket 240 may include a hinge which enables a circular hole defined by the pivot bracket 240 to open and clasp around the connector portion 226 of the support structure 220. In some such examples, the pivot bracket 240 may include a fastener, clasp, clamp, or other method of attachment to secure the pivot bracket 240 around the connector portion 226 of the support structure 220.

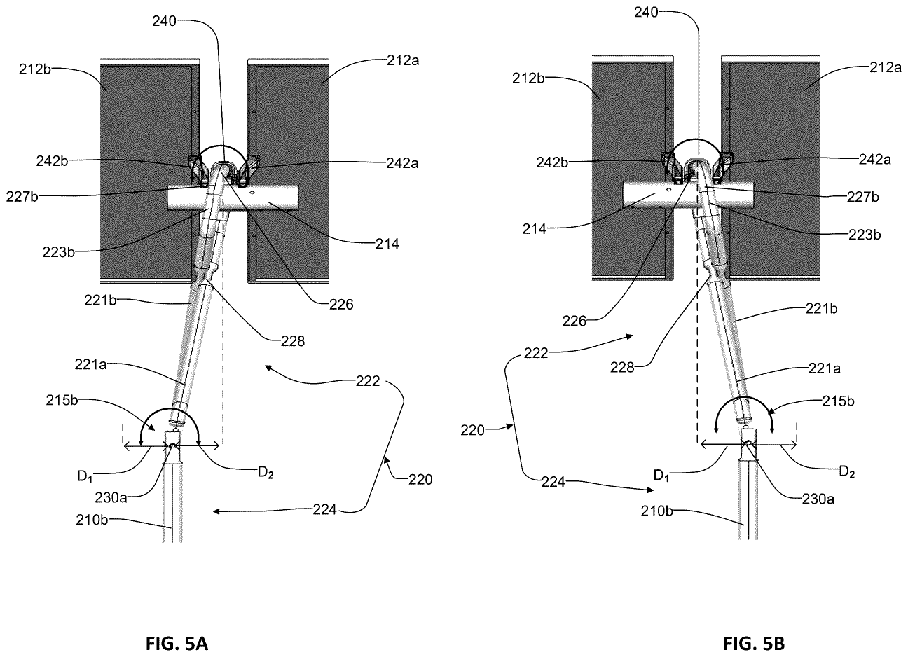

FIG. 5A is a side view of the example solar tracker 200 in a first rotated position and FIG. 5B is a side view the example solar tracker 200 in a second rotated position. In the first rotated position, the upper portion 222 of the support structure 220 is maximally rotated clockwise relative to the lower portion 224 about the axis defined along the fastener 230a (e.g., axis 350 of FIG. 6). Thus, instead of being in-line with (e.g., directly above) the lower portion 224, the upper portion 222 extends rightward of the lower portion 224 in the first rotated position. In the second rotated position, the upper portion 222 of the support structure 220 is maximally rotated counterclockwise relative to the lower portion 224 about the axis defined along the fastener 230a. Thus, instead of being in-line with the lower portion 224, the upper portion 222 extends leftward of the lower portion 224 in the second rotated position.

As described elsewhere herein, the upper portion 222 is rotatably coupled to the lower portion 224 (e.g., via a fastener 230a, 230b, pin, or the like) and can rotate relative to the lower portion 224 as illustrated by the double-sided arrow centered about the axis of rotation. The upper portion 222 can rotate relative to the lower portion 224 partly because of the use of a single fastener 230a, 230b, which defines an axis about which the upper portion 222 can rotate (e.g., 350 of FIG. 6), and because the upper portion 222 has end portions that are coupled to top portions of the lower portion 224. In other terms, the upper portion 222 has some play (e.g., space) with the lower portion 224 that enables the relative rotation between the upper portion 222 and the lower portion 224.

Because the pivot bracket 240 is rotatably coupled to the upper portion 222, when the upper portion 222 rotates relative to the lower portion 224, as in the first or second rotated positions, the pivot bracket 240 also rotates, as indicated by the double-sided arrow centered about the axis of rotation. As described elsewhere herein, the pivot bracket 240 rotates about an axis (e.g., 252 of FIG. 6) defined by the connector portion 226 of the upper portion 222 and thus rotates relative to the upper portion 222. Further, because the pivot bracket 240 is coupled to the torque tube 214 via torque tube clamps (e.g., torque tube clamps 244a, 244b shown in FIG. 6), and because the pivot bracket 240 rotates when the upper portion 222 rotates relative to the lower portion 224, rotation of the upper portion 222 relative to the lower portion 224 does not translate to the torque tube 214. Instead, the rotation of the pivot bracket 240 maintains the torque tube 214 in an approximately level position. In some examples, with the rotation of both the upper portion 222 relative to the lower portion 224 and the rotation of the pivot bracket 240 relative to the upper portion 222, solar modules 212a, 212b attached to the torque tube 214 via rails (e.g., rails 242a, 242b shown in FIG. 6) may move laterally relative to the ground, and a height of the torque tube 214 relative to the ground may slightly decrease while remaining approximately level.

The rotational movement of the upper portion 222 relative to the lower portion 224 enables the torque tube 214 to significantly expand and/or contract lengthwise (e.g., due to thermal expansion) without adding significant stress to the overall support structure. Lengthwise thermal expansion/contraction of the torque tube 214 is transferred into rotational movement of the upper portion 222 relative to the lower portion 224 through the various couplings, including the rotation of the pivot bracket 240. For example, in FIG. 5A, thermal expansion/contraction of the torque tube 214 can cause the torque tube 214 to impart a lateral force to the pivot bracket 240. Because the pivot bracket 240 is rotatably coupled to the connector portion 226 of the support structure 220, the lateral force causes the pivot bracket 240 to rotate relative to the connector portion 226 and transfer the lateral force to the connector portion 226 of the support structure 220. Further, because the upper portion 222 is rotatably coupled to the lower portion 224, the lateral force at the connector portion 226 of the support structure 220 causes the upper portion 222 to rotate clockwise relative to the lower portion 224.

Compared to other support structures, the transfer of lengthwise thermal expansion into rotational movement of the upper portion 222 relative to the lower portion 224 can enable significant thermal expansion/contraction of the torque tube 214 without adding stress to the support structure 220. For instance, the amount of thermal expansion of the torque tube 214 that the support structure 220 of FIGS. 5A and 5B can compensate for includes the added distances D₁ and D₂. The distance D₁ is defined as the horizontal distance between the center of the connector portion 226 of the support structure 220 in the first rotational position (e.g., maximum rotation of the upper portion 222 relative to the lower portion 224 in the counterclockwise direction) relative to a center of the lower portion 224, which extends along the lower portion 224. Similarly, the distance D₂ is defined as the horizontal distance between the center of the connector portion 226 of the support structure 220 in the first rotational position (e.g., maximum rotation of the upper portion 222 relative to the lower portion 224 in the clockwise direction) relative to a center of the lower portion 224, which extends along the lower portion 224.

FIG. 6 is a perspective view of the support structure 220 in an exploded configuration, and FIG. 7 is a perspective view of the support structure 220. As previously discussed with reference to FIGS. 3 and 4, the pivot bracket 240 may be configured to be rotatably coupled to the connector portion 226 of the support structure 220 and may be configured to support/effectively couple the torque tube 214 to the support structure 220. In some examples, as there may be a circular hole defined by the pivot bracket 240, the connector portion 226 of the support structure 220 may be circular. However, the connector portion 226 of the support structure 220 may include a smaller diameter than the circular opening defined by the pivot bracket 240. The smaller diameter of the connector portion 226 relative to the circular hole of the pivot bracket 240 may enable the pivot bracket 240 to rotate about the connector portion 226. In FIG. 6, the pivot bracket 240 is rotatable about a horizontal axis 252 defined by the connector portion 226 of the support structure 220. The horizontal axis 252 is defined along the center of the circular connector portion 226 of the support structure 220. In some examples, the pivot bracket 240 is freely rotatable (e.g., without frictional binding) about the connector portion 226. Alternatively, in some examples, the pivot bracket 240 is not freely rotatable about the horizontal axis 252 and requires a certain amount of force to overcome friction between the pivot bracket 240 and the connector portion 226 of the support structure 220. In some examples, the pivot bracket 240 may be adjustable between freely rotating about the connector portion 226 and being fixed to the connector portion 226. For instance, if the pivot bracket 240 includes a hinge to open and clasp around the connector portion 226, the fastener, clamp, or other method of attachment to secure the pivot bracket 240 around the connector portion 226 can be tightened/loosened to increase/decrease the amount of force necessary to overcome friction between the pivot bracket 240 and the connector portion 226 of the support structure 220.

The pivot bracket 240 may include a pivot pin 241 which effectively couples the torque tube 214 to the support structure 220 to support the torque tube 214. In the example of FIG. 6, the pivot pin 241 may extend on either side of the pivot bracket 240 along an axis 254. Each side of the pivot pin 241 is received by an opening defined by a torque tube clamp 244a, 244b and rotatably couples the torque tube clamps 244a, 244b to the pivot bracket 240. As with the opening defined by the pivot bracket 240, the openings defined by the torque tube clamps 244a, 244b are sized to be larger than the pivot pin 241 such that the torque tube clamps 244a, 244b can freely (e.g., with minimal friction) rotate about the pivot pin 241.

The torque tube clamps 244a, 244b are configured to secure to the torque tube 214 and couple the torque tube 214 to the support structure 220 via the rotatable coupling between the torque tube clamps 244a, 244b and the pivot pin 241 of the pivot bracket 240. The torque tube clamps 244a, 244b can be transitioned between a first, open position, where the torque tube 214 can be inserted into a torque tube clamp 244a, 244b and is free to move within the torque tube clamp 244a, 244b, and a second, closed or clamped position, where the torque tube clamp 244a, 244b secures or otherwise inhibits movement of the torque tube 214 within the torque tube clamp 244a, 244b. The torque tube 214 is effectively supported by the support structure 220 and can rotate about the axis 254 defined by the pivot pin 241 when the torque tube clamps 244a, 244b are rotatably coupled to the pivot pin 241 of the pivot bracket 240 and are in the closed/clamped position.

Continuing with the example of FIG. 6, the support structure 220 includes rails 242a, 242b. The rails 242a, 242b are configured to secure to one or more solar modules (e.g., solar modules 212a, 212b) to the torque tube 214 to enable the solar modules to rotate with rotation of the torque tube 214 (e.g. to track movement of the sun). The rails 242a, 242b can be secured to the one or more solar modules via one or more fasteners, though other securing means are contemplated (e.g., clamps, welding, etc.) The rails 242a, 242b can be directly secured to the torque tube 214 via one or more fasteners (e.g., bolts, screws, and the like). However, in some examples, the rails 242a, 242b can be secured to the torque tube 214 via the torque tube clamps 244a, 244b. In some such examples, the torque tube clamps 244a, 244b can be in mechanical communication with the rails 242a, 242b. For instance, a top portion of a torque tube clamp 244a, 244b can be received within a rail 242a, 242b such that when a lower portion of the torque tube clamp 244a, 244b is transitioned (e.g., tightened) to the closed/clamped position, the torque tube clamp 244a, 244b forces the rail 242a, 242b to frictionally couple to (e.g., fixedly attach to) the torque tube 214. In some examples, the rails 242a, 242b may be coupled to the torque tube clamps 244a, 244b via clinching (e.g., a clinch joint). When the rails 242a, 242b have been coupled to the torque tube clamps 244a, 244b, the rails 242a, 242b may then be fastened to the torque tube 214 via a fastener, such as, a U-bolt. In some examples, a combination of directly fixing the rails 242a, 242b to the torque tube 214 via fasteners (e.g., U-bolts) and indirectly fixing the rails 242a, 242b to the torque tube 214 via torque tube clamps 244a, 244b can be used.

FIG. 7 shows an enlarged view of the second attachment joint 215b in Box 7. As discussed elsewhere herein, the first end portion 225a of the first angled leg 221a may be coupled to the second top portion 211b of the second pile 210b. In some examples, the first end portion 225a of the first angled leg 221a may include the plurality of holes 229a. The plurality of holes 229a of the first end portion 225a may be configured to align with the one or more holes 213b (not explicitly seen in Box 7) of the second top portion 211b of the second pile 210b. Once aligned, the first end portion 225a and the second top portion 211b may be coupled together via the fastener 230b. As shown, the fastener 230b may pass through one of the plurality of holes 229a and the one or more holes 213b, thereby rotatably coupling the first angled leg 221a to the second pile 210b.

As shown in FIG. 7, the first end portion 225a may be positioned adjacent (e.g., next to) the second top portion 211b. This positioning allows for greater rotational movement of the upper portion 222 relative to the lower portion 224, thereby enabling the torque tube 214 to significantly expand and/or contract lengthwise (e.g., due to thermal expansion) without adding significant stress to the overall support structure 200. The rotational movement of the upper portion 222 relative to the lower portion 224 may be dependent upon the fastener 230b. For example, if the desired rotational movement is over an arc distance of about 90-degrees (e.g., ±45-degrees in either direction), the fastener 230b may provide a looser connection to enable such rotational movement while maintaining a secure hold. In other examples, if the desired rotational movement is less than an arc distance of about 90-degrees, the fastener 230b may provide a tighter connection to provide some flexibility while maintaining a more controlled rotational movement. While it is described that the arc distance may be about 90-degrees, it should be understood that the arc distance may further be greater than 90-degrees or less than 90-degrees. It will be appreciated that while the second attachment joint 215b has been described with reference to Box 7, the description of the second attachment joint 215b further applies to the first attachment joint 215a.

FIG. 8A is a front view of the upper portion 222 of the support structure 200, and FIG. 8B is a side view of the upper portion 222 of the support structure 200. The cross-over intersection 228 of the first angled leg 221a and the second angled leg 221b enables further rotational movement by creating space for the first solar module 212a and the second solar module 212b. For example, if the first solar module 212a and the second solar module 212b are in a max tilt position, and the torque tube 214 undergoes thermal expansion, the upper portion 222 of the support structure 220 may rotate to a maximally rotated position (e.g., first rotated position, second rotated position) relative to the lower portion 224 without interference from the first solar module 212a and/or the second solar module 212b. In other words, the cross-over intersection 228 provides a full range of rotational movement without obstruction.

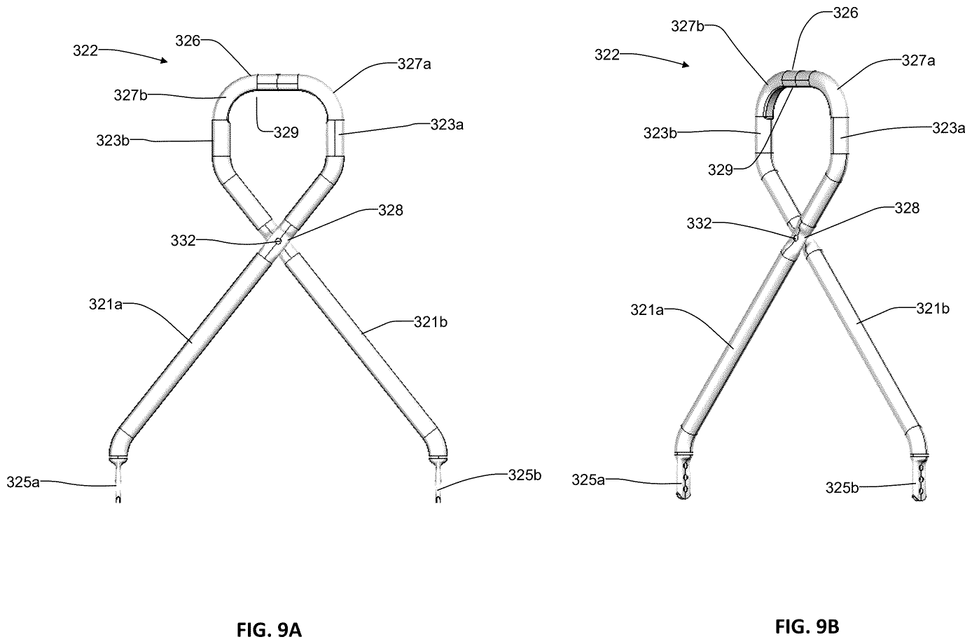

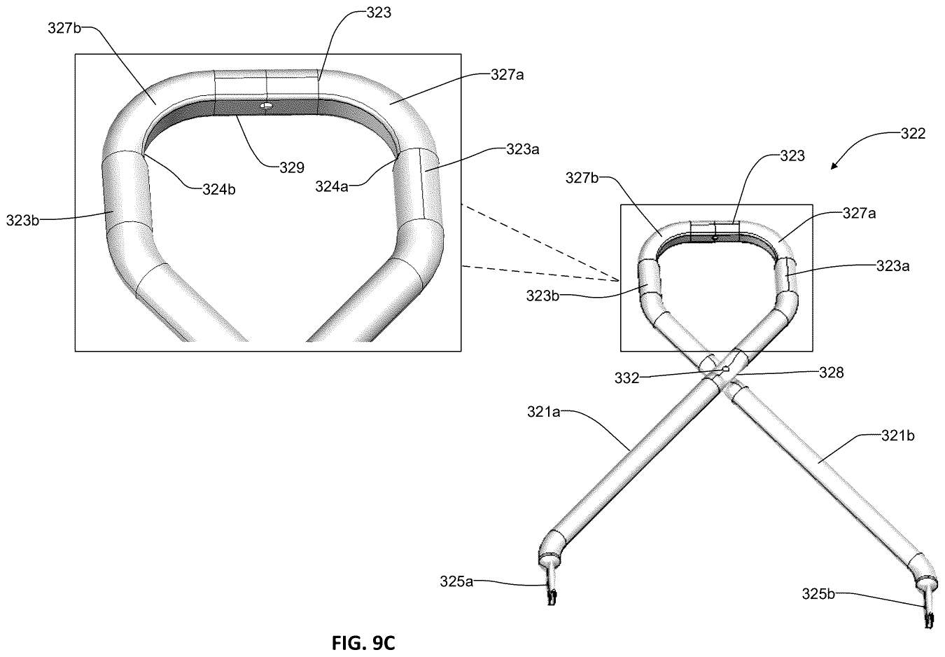

FIG. 9A is a front view of an upper portion 322 that may be used in the support structure 200, FIG. 9B is a side-perspective view of the upper portion 322, and FIG. 9C is a bottom-perspective view of the upper portion 322. As stated, the upper portion 322 may be used in the support structure 200. As such, the upper portion 322 may be configured to be coupled to the lower portion 224 of the support structure 200 at the first attachment joint 215a and the second attachment joint 215b. The upper portion 322 is like the upper portion 222 described herein, however, the upper portion 322 differs from the upper portion 222 in that the upper portion 322 includes a flat portion 329 on an underside of a connector portion 326. It will be appreciated that the description of the upper portion 222 described elsewhere herein, further applies to the upper portion 322.

As shown best in FIG. 9C, the flat portion 329 may include a first stop 324a and a second stop 324b positioned adjacent a first end 327a and a second end 327b of the connector portion 326, respectively. In other words, the first stop 324a and the second stop 324b may be positioned at corners of an underside of the connector portion 326. The first stop 324a and the second stop 324b may serve as hard stops for the torque tube 214, thereby preventing the torque tube 214 from rotating beyond the first stop 324a and the second stop 324b. In such examples, an arc distance of the torque tube 214 may be limited to a desired range.

Various non-limiting exemplary embodiments have been described. It will be appreciated that suitable alternatives are possible without departing from the scope of the examples described herein.

1. A support structure comprising:
an upper portion including a first angled leg and a second angled leg, the first angled leg and the second angled leg coupled to each other proximate a top of the upper portion, the first angled leg and the second angled leg crossing over each other at an intersection; and
a lower portion including a first ground pile and a second ground pile, the first angled leg configured to couple to the second ground pile via a second joint and the second angled leg configured to couple to the first ground pile via a first joint.

2. The support structure of claim 1, wherein the first angled leg and the second angled leg are coupled at the top of the upper portion via a connector portion, the first angled leg coupled to a first end of the connector portion and the second angled leg coupled to a second end of the connector portion.

3. The support structure of claim 1, wherein the first angled leg is coupled to an exterior surface of the second ground pile, and the second angled leg is coupled to an exterior surface of the first ground pile.

4. The support structure of claim 1, wherein the first angled leg comprises a first top portion and a first end portion, and the second angled leg comprises a second top portion and a second end portion.

5. The support structure of claim 4, wherein the first ground pile includes a first top portion, the first top portion of the first ground pile defining a first hole for the first joint, the second end portion of the second angled leg defining a second hole for the first joint, the first hole and the second hole of the first joint being aligned when the second angled leg is coupled to the first ground pile via a fastener passing through the first hole and the second hole, the first joint enabling relative movement between the second angled leg and the first ground pile.

6. The support structure of claim 4, wherein the second ground pile includes a second top portion, the second top portion of the second ground pile defining a first hole for the second joint, the first end portion of the first angled leg defining a second hole for the second joint, the first hole and the second hole of the second joint being aligned when the first angled leg is coupled to the second ground pile via fastener passing through the first hole and the second hole, the second joint enabling relative movement between the first angled leg and the second ground pile.

7. The support structure of claim 4, wherein the first top portion and the second end portion are located on a first side of the intersection, and the second top portion and the first end portion are located on a second side of the intersection, the second side being opposite the first.

8. The support structure of claim 1, wherein the first angled leg and the second angled leg are further coupled to each other at the intersection.

9. The support structure of claim 8, wherein the first angled leg and the second angled leg couple to each other at the intersection via a fastener, the fastener enabling relative rotation between the first angled leg and the second angled leg about the fastener.

10. The support structure of claim 1, wherein proximate the intersection, each of the first angled leg and the second angled leg include a swaged portion, each of the swaged portions having an outer diameter that is less than an outer diameter of the respective first angled leg or the second angled leg.

11. The support structure of claim 1, wherein the upper portion is configured to rotate relative to the lower portion.

12. A solar tracker system comprising:
a plurality of support piers including a first support pier and a second support pier, each of the first and second support piers comprising:
a lower portion having a first ground pile and a second ground pile configured to be at least partially embedded within the ground; and
an upper portion having a first angled leg and a second angled leg coupled to each other proximate a top of the upper portion, the upper portion configured to be coupled to the lower portion via a first attachment joint and a second attachment joint, the upper portion configured to rotate relative to the lower portion via the first attachment joint and the second attachment joint;
a torque tube rotatably supported by the plurality of support piers;
a plurality of solar modules coupled to the torque tube; and
a drive motor configured to cause the torque tube to rotate.

13. The solar tracker system of claim 12, wherein the first angled leg and the second angled leg cross over each other at an intersection.

14. The solar tracker system of claim 13, wherein the first angled leg and the second angled leg are coupled to each other at the intersection.

15. The solar tracker system of claim 14, wherein the first angled leg and the second angled leg couple to each other at the intersection via a fastener, the fastener enabling relative rotation between the first angled leg and the second angled leg about the fastener.

16. The solar tracker system of claim 12, wherein each of the first and second support piers further comprises a connector portion coupling the first angled leg and the second angled leg together, the connector portion coupled at a first connector end to the first angled leg and at a second connector end to the second angled leg.

17. The solar tracker system of claim 12, wherein the first angled leg comprises a first top portion and a first end portion, and the second angled leg comprises a second top portion and a second end portion, the first end portion and the second end portion being swaged.

18. The solar tracker system of claim 12, wherein the first angled leg comprises a first top portion and a first end portion, and the second angled leg comprises a second top portion and a second end portion, the first end portion and the second end portion being at least partially flattened.

19. The solar tracker system of claim 12, wherein the first angled leg is coupled to the second ground pile via the second attachment joint via a fastener, about which the first angled leg rotates relative to the second ground pile.

20. The solar tracker system of claim 12, wherein the second angled leg is coupled to the first ground pile via the first attachment joint via a fastener, about which the second angled leg rotates relative to the first ground pile.
